(19) United States
(12) Patent Application Publication
(10) Pub. No.: US 2009/0296551 A1
(43) Pub. Date: Dec. 3, 2009

(54) TRANSITION SHIFT TIMING FOR OPTICAL SIGNAL

(75) Inventor: Ruud Vlutters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,541

(22) PCT Filed: Dec. 14, 2005
(86) PCT No.: PCT/IB05/54247

§ 371 Date: Jun. 13, 2007

(30) Foreign Application Priority Data
Dec. 20, 2004 (EP) 04106739.8

(51) Int. Cl. G11B 27/36

(52) U.S. Cl. 369/53.22; G9B/27.052

(57) ABSTRACT

A method of determining the transition shift timing in a measured optical signal from an optical recording medium as well as applications of the method in connection with optimizing a write strategy and analyzing the write quality for an optical recording medium are disclosed. The method comprising the step of: providing values of a measured optical signal, providing modulation bits corresponding to the measured optical signal, calculating a model signal by means of an optical channel model, and determining an output timing of the leading and trailing edges from a mathematical model. The method being a recursive method which is continued until a predetermined criterion is fulfilled. The final output is the average transition shifts of the channel bits of the measured CA signal as they are on the optical recording medium. The applications of the method include but are not limited to: a module for determining the average transition shifts, an optical recording apparatus with means for adjusting the write strategy according to the average transition shifts, and an IC for controlling an optical recording apparatus.

The invention relates to a method of determining transition shift timing in an optical signal from an optical recording medium and to applications of the method in connection with optimizing a write strategy and analyzing the write quality for an optical recording medium.

The technology of reading and writing information to and from optical disks has made remarkable advancements in recent years. With the advancement of the technology various types of recording formats and corresponding media has emerged. On the market today there exists inter alia, read-only media, i.e. ROM-disks such as for music play-back, write-once optical disks, where data may be written only once but read many times, and rewritable disks for recording and erasing data multiple times. These three different formats each have a raison d'être, and each have strengths and weaknesses. Common for the three types is a wish of increasing the data capacity, so that more data may be present or provided onto a single disk.

There is, however, a number of limiting factors for the size of the data capacity. One important factor is the size of the optical spot, which on high-capacity disks becomes almost as large as the size of the smallest optical effects on the disk. In this limit, information of more than one single bit may be detected by the optical spot resulting in inter-symbol interference (ISI).

In the Blu-ray disk (BD) format it is possible to analyze the time between slicer crossing for capacities up to 27 GB, and thereby determine the lengths of the optical effects. But for capacities above 27 GB it is no longer possible to unambiguously determine the slicer level, and also the well known jitter analysis in connection with optimum power calibration (OPC) for adjusting the write strategy in a recording mode, is not possible.

The inventors of the present invention have appreciated that currently no solution exists to analyze the length of written effects on an optical medium for capacities in the 30-37 GB range, such a solution is of benefit, and the inventors have in consequence devised the present invention.

The present invention seeks to provide improved means for detecting and analyzing written effects on an optical medium. Preferably, the invention alleviates or mitigates one or more of the above or other disadvantages singly or in any combination.

Accordingly there is provided, in a first aspect, a method of determining the timing of transition shifts in a series of channel bits in a measured optical signal from an optical recording medium, the optical signal comprising first sections reflected from first regions with first widths, and second sections reflected from second regions with second widths, wherein transitions from the first to the second regions are labeled leading edges indexed by the first and second widths and transitions from the second regions to the first regions are labeled trailing edges indexed by the second and first widths, the method comprising the steps of:

a) providing values of a measured optical signal in the form of a central-aperture signal (CA signal),
b) providing modulation bits corresponding to the measured optical signal,
c) calculating a model signal by means of an optical channel model, the calculated model including an input timing of the leading and trailing edges, the input timing being a series of input transition shifts,
d) determining an output timing of the leading and trailing edges from a mathematical model taking the measured optical signal, the modulation bits and the calculated model signal in account, the output timing being a series of output transition shifts,
wherein the input timing used in an evaluation step is the output timing determined in a precedent evaluation step, and wherein the difference between the model and measured signal is used together with the input timing to calculate a subsequent output timing, and
e) continuing the evaluation series until a series of output transition shifts obtained in a specific evaluation step fulfils a predetermined criterion,
wherein the last obtained series of output transition shifts is the average transition shifts of the channel bits of the measured CA signal.

A measured optical signal, such as a measured optical signal from a read-only, write-once, rewritable, etc. CD-type disk, DVD-type disk, BD-type disk etc., is a modulated signal wherein the modulation represents the binary data present on the disk. On the disk information is stored in a pattern of optical effects, e.g. referred to as marks. A typical encoding of the information is the runlength encoding, where information is stored in optical effects and spaces between the optical effects, as wells as the lengths of the optical effects and the spaces. The bit pattern on a disk may in the runlength encoding be represented by a timing sequence of transition shifts between spaces and optical effects. The bit type (i.e. optical effect or space) and bit length may be deduced from the type of transition shift and the timing between the transition shifts.

Modulation bits corresponding to the measured optical signal are provided. The modulation bits may be detected from the optical medium, i.e. deduced from the measured optical signal, or the modulation bits may already be stored in a memory and thereby known to the system. The modulation bits are the resulting bits from which information is extracted, ideally the modulation bits correspond to the channel bits (being the bits as they are on the disk) transition shifts may, however, introduce a difference or lead to a deteriorated bit determination.

The optical signal thus comprises first and second sections corresponding to whether the light was reflected from first or second regions. The first and second regions may be identifies as spaces and marks respectively in a phase-change type disk or write-one type disk, as pits and lands in a ROM-type disk, etc. The transitions from the first to the second regions are labeled leading edges indexed by the first and second widths (also referred to as lengths) and transitions from the second regions to the first regions are labeled trailing edges indexed by the second and first widths (lengths). In a phase-change type disk, leading edges refer to transitions from high reflectivity regions to low reflectivity regions and trailing edges the other way around.

It is advantageous to determining the timing of transition shifts in a series of channel bits from a comparison between the measured CA signal and a calculated model signal of the CA signal, since the CA signal is the detected signal and the last obtained series of output transition shifts is the average transition shifts of the channel bits of the measured CA signal, and thereby directly reflects transition shifts as they are on the disk.

The method of the present invention render it possible to obtain transition shifts as they are on the disk even for such data capacities as capacities above 30 GB, such as in the range 30-37 GB. This is an advantage since currently no alternative method exists.

The calculated model signal, i.e. the calculated model CA signal, may mathematically be represented by a linear optical model approximated by a discrete finite impulse response (FIR) implementation. The linear optical model may be the Braat-Hopkins model. It is an advantage to use a linear model since such models exist which describe the optical channel well, e.g. the Braat-Hopkins model, and linear models are well-suited for automated modeling implemented by processor means.

Both the measured optical signal and the calculated model signal may mathematically be represented by a bit-synchronous approximation, the synchronization being with the modulation bits on the optical medium. This is an advantage since optical apparatuses phase lock the measured optical signal to a apparatus generated clock signal by means of a PLL-mechanism, the model signal thereby reflects the real measured signal as processed in the apparatus.

The difference between the model and the measured signal may be minimized in an error loop where the parameter that is minimized is the mean square error of the difference between the measured and calculated model signal. This is an advantage since such minimization methods are well established and a such methods may be robust with respect to finding the proper minimum in a large parameter space, and where a proper predetermined criterion used as measure of a sufficient match between the model and the measured signal can be provided. The predetermined criterion may be such as a value or a percentage of the measured signal that the error should be below. The predetermined criterion may, however, also be a given number of evaluation steps that should be performed (including a single evaluation step).

The timing of the leading and trailing edges may be determined as a function of width of the region prior to a specific transition shift and the width of the following region. For example, the timing of a given leading edge may be determined as a function of width of the specific (or current) mark and the previous space length, and the timing of a given trailing edge may be determined as a function of the width of the specific (or current) mark and the next space. This may be represented in a 2D matrix, an L-matrix, for leading edges with the matrix elements being arranged as (current mark, previous space), and a 2D T-matrix for trailing edges with the matrix elements being arranged as (current mark, next space). It is an advantage to determine the timing of the leading and trailing edges in this manner, since it directly provides the systematic behavior of the various pattern combinations present on a disk, and thereby directly reveals a systematic error in the time positioning of the various pattern combinations. Such a matrix representation thus provides a simple and useful qualification system.

In the simplest method optical effects are provided to an optical medium by turning the laser on at a predetermined power lever for a predetermined duration depending upon the desired length of optical effect, and turning the laser off between the optical effects for a duration corresponding to a desired length of the space. However, the write strategy may be more complex than this, for example in connection with the direct overwrite method (DOW) used in connection with phase-change type media. In general the optical effects are written by means of laser pulses with a pulse shape characterized by a number of write parameters, this is referred to as a write strategy. Typically, the write strategy may be described by a number of write parameters such as commands to turn laser power on and off, setting the laser power to a specific level, maintaining the laser power for a given duration, etc. It is important, and sometimes even necessary, to calibrate, i.e. optimize, the write strategy before writing data on a new optical recordable medium.

The write strategy describing a desired write pulse may include one or more write parameters. The write strategy may depend upon the desired specific optical effect, i.e. the length of the effect and the write parameters in a write pulse for writing a specific optical effect. Standard write strategies may exist categorized according to the resulting length of the written optical effect, i.e. I2-strategies for writing I2-marks, I3-strategies for writing I3-marks, etc. The write strategies, i.e. the write parameters included in a specific write strategy, may be optimized according to an average transition shifts of a specific type of leading and/or trailing edge.

It is an advantage to be able to directly correlate a timing, and thereby a possible error in the timing of a given optical effect of a specific leading and/or trailing edge to one or more specific write parameters in a write pulse, since errors in the timing of the bit sequence is a deviation from the optimal situation and will result in a deteriorated detection performance. As a result, reading data from a medium with non-optimal optical effects is prone to errors. Being able to correlate a timing error (i.e. an error in the length of the optical effect or space between optical effects) to one or more specific write parameters facilitates means for optimizing the write parameters and thereby provide media were optical effects are written optimally, or at least in an improved manner.

In a second aspect of the present invention, a write strategy may be optimized by performing the steps of

α) reading a pattern of optical effects from an optical storage medium, the pattern including one or more optical effects, each of the one or more optical effects being associated with a predetermined write strategy, the write strategy including one or write parameters,
β) performing the method according to claim 1 and thereby provide the average transition shifts of the channel bits of the measured CA signal, and
γ) adjusting the one or more write parameters by means of a set of predetermined rules.

This optimization method may be a one-step method or alternatively it may be an recursive process where the method is repeated e.g. in a specific region on an optical disk, such as a power calibration region (PCA) provided on some disks.

The method according to the first aspect and/or second aspect may be implemented in a module according to a third aspect of the present invention. The implementation may be provided by means of software implementation or hardware implementation, e.g. in an implementation comprising one or more ICs, or any other suitable way of implementation.

The module comprising:

a first input section for inputting the CA signal in a form of a measured sampled waveform,
a second input section for inputting a channel bit stream,
means for processing the CA signal and the channel bit stream in accordance with the method of the first aspect, and
an output section for outputting the average transition shifts of the channel bits of the measured CA signal, and
optionally processing means for evaluating the transition shifts in accordance with rules.

The module thus comprises input sections for inputting signals, a processing section for processing the inputted signals and an output section for outputting a result. The input section may be hardware section, e.g. an interface means for interfacing one or more signals to a processing means, however in general the input sections may be any type of means provided for feeding or providing one or more signals to processing means. The input signal may be an output signal from a given unit, e.g. an input signal may be a signal provided by a bit detector where the analogue reflected lights as detected by a photodetector is transformed into a binary bit stream, i.e. the modulation bit stream. The modulation bit stream may alternatively already be known, e.g. from a memory. The processing means may be any type of processing means, both dedicated processing means, dedicated to perform the method of the first aspect of the present invention, or the processing means may be part of general purpose computer, such as a computer program. The outputting section may be a storage means enabling access to the result or the outputting section, e.g. as an intermediate step in connection with showing the result graphically.

Optionally, the module may comprise processing means for evaluating the result in accordance with rules. Such rules may be known to the evaluation means and e.g. provide means for detecting a given transition shift and adjusting a power level or level duration in accordance with the rules.

It is an advantage to provide a module since the module may be part of a device for performing an optimal power calibration, may be part of an analyzer for analyzing the quality of written optical effects on a disk, etc.

According to a fourth aspect, the invention relates to an optical recording apparatus comprising:

a radiation source for emitting a radiation beam having a controllable value of a write power level for recording optical effects on the recording medium,

a read unit for reading the recorded effects,

means adjusting the power level and/or level duration in a write strategy according to the average transition shifts of a specific type of leading and/or trailing edge of the measured CA signal as determined by the method of the first aspect.

According to a fifth aspect, the invention relates to an integrated circuit (IC) for controlling an optical recording apparatus, the IC being adapted to adjusting one or more write parameters in a write strategy according to the average transition shifts of a specific type of leading and/or trailing edge of the measured CA signal as determined by the method of the first aspect.

According to a sixth aspect, the invention relates to a computer readable code adapted to perform the method of the first aspect.

The various aspects of the invention may be combined and coupled in any way possible within the scope of the invention.

These and other aspects, features and/or advantages of the invention will be apparent from and elucidated with reference to the embodiments described hereinafter. Embodiments of the invention will be described, by way of example only, with reference to the drawings, in which

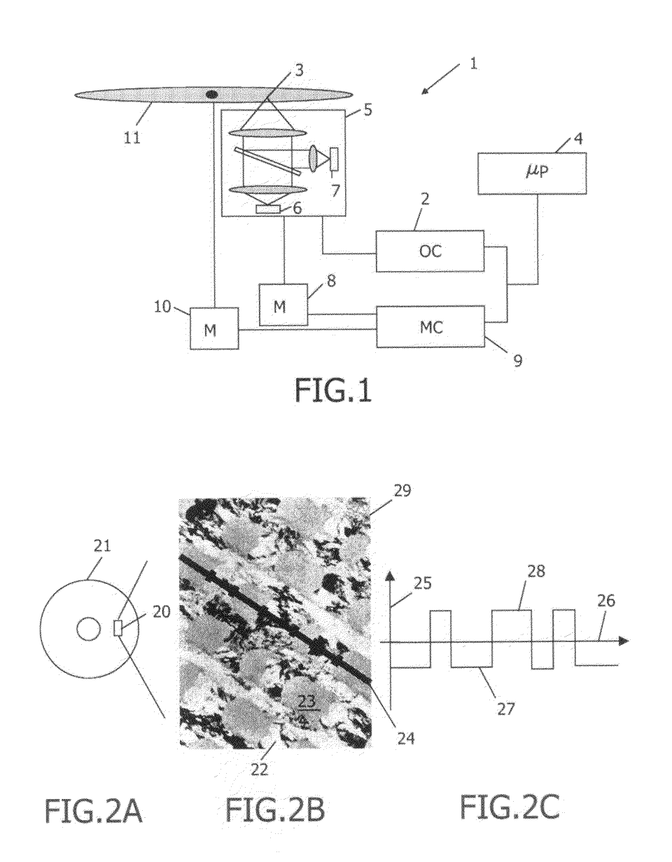

FIG. 1 schematically illustrates an optical recording apparatus capable of reading and/or writing information from and/or to an optical storage medium,

FIG. 2 schematically illustrates optical effects on a Blu Ray disk,

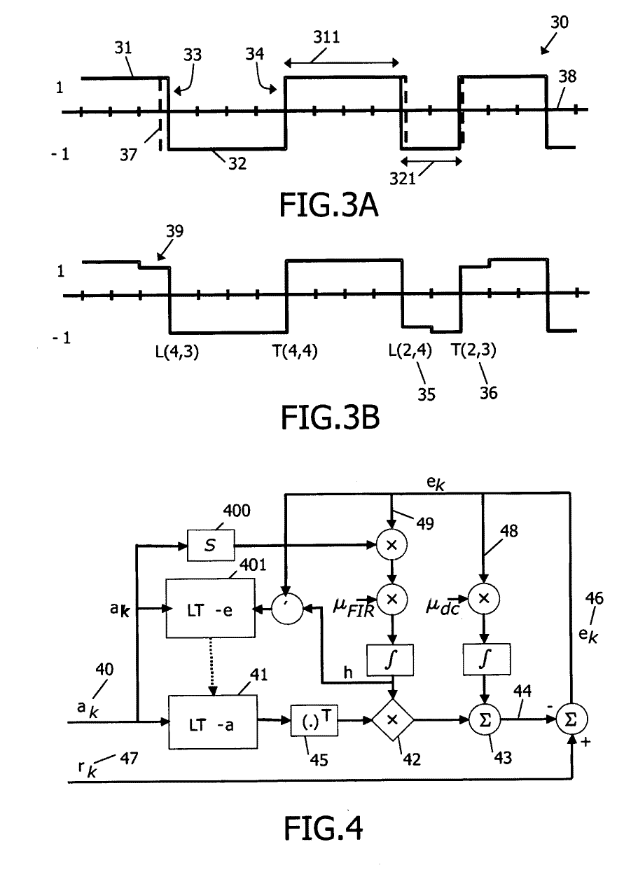

FIG. 3 schematically illustrates two series of channel bits from an optical signal

FIG. 4 illustrates an embodiment of an implementation of the method according to the present invention,

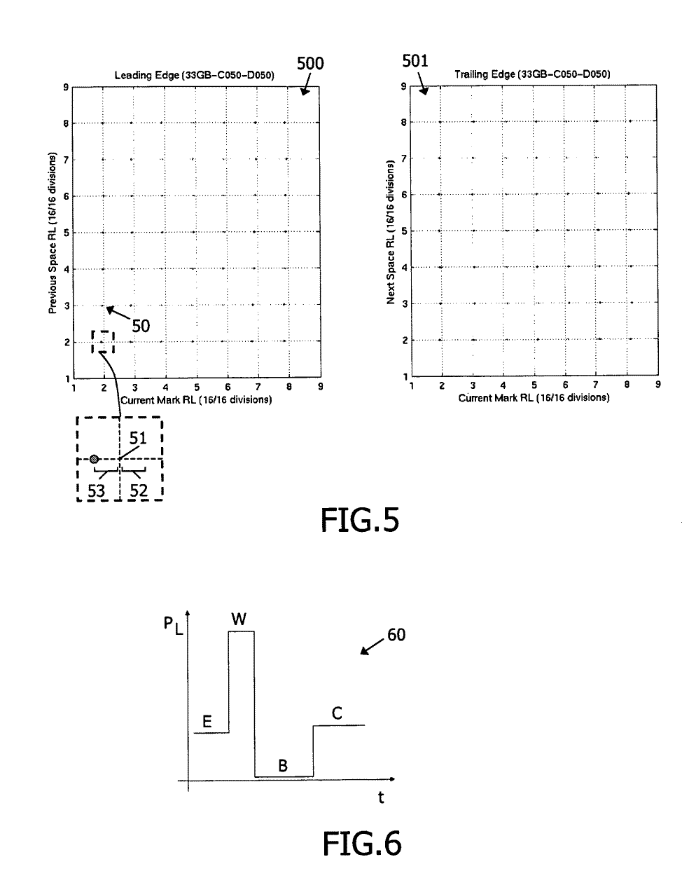

FIG. 5 illustrate matrix plots of leading and trailing edges (LT-matrixes) obtained in accordance with an embodiment of the present invention,

FIG. 6 shows a schematic drawing of the I2-mark write strategy,

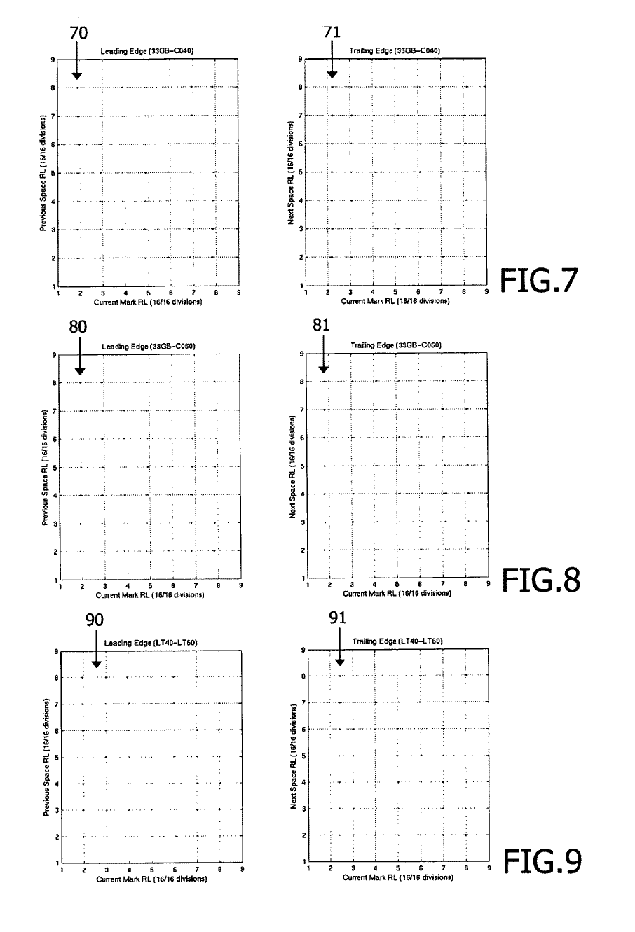

FIG. 7 illustrates LT-matrixes obtained for first I2-write strategy,

FIG. 8 illustrates LT-matrixes obtained for second I2-write strategy,

FIG. 9 illustrates the LT-matrixes of FIG. 7 minus those of FIG. 8,

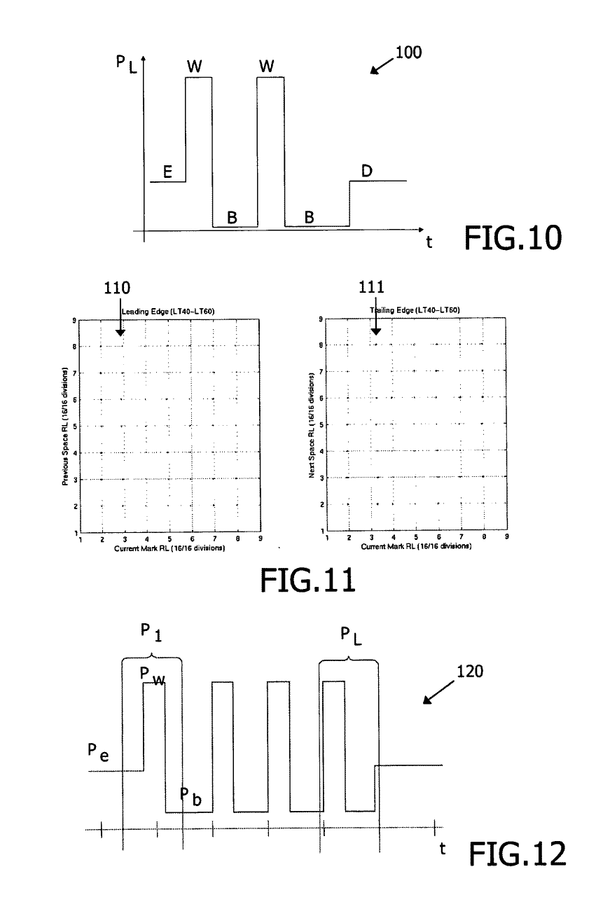

FIG. 10 shows a schematic drawing of the I3-mark write strategy,

FIG. 11 illustrates subtraction LT-matrixes obtained for different I3-write strategies,

FIG. 12 shows a schematic drawing of a general write strategy,

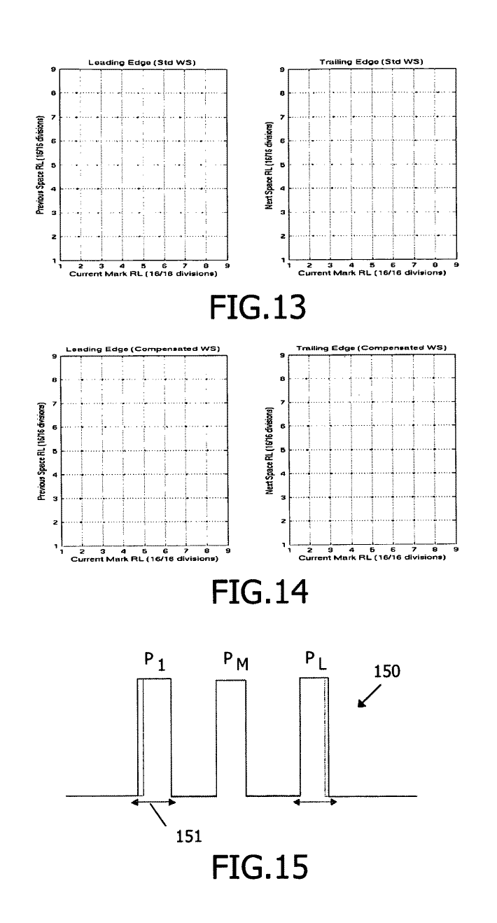

FIG. 13 illustrates LT-matrixes obtained using a first version of the write strategy of FIG. 12,

FIG. 14 illustrates LT-matrixes obtained using a second version of the write strategy of FIG. 12, and

FIG. 15 shows a schematic drawing of an I4-write pulse.

An optical recording apparatus I capable of reading and/or writing information from and/or to an optical storage medium is schematically illustrated in FIG. 1.

A real optical recording apparatus comprises a large number of elements with various functions, only a few are illustrated here. Motor means 8,10 are present for rotating the disk 11 and controlling the motion of an optical pickup unit 5, so that an optical spot 3 can be focused and positioned at a desired location on the disk. The optical pickup unit includes a laser 6 for emitting a laser beam which may be focused on the disk by means of a number of optical elements. The focused laser light may in a recording mode be sufficiently intense so that a physical change may be provided to the optical disk, i.e. optical effects are provided onto the disk. Alternatively, in a reading mode the laser power is insufficient to induce a physical change and the reflected laser light is detected by a photodetector 7 for reading the optical effects on the disk.

The present invention deals both with the reading and writing aspect of optical apparatus, since data may be read in order to determine the write quality, and data may be written using an optimized write strategy.

The control of the recording apparatus may be done either by hardware implementation, such as illustrated by the motor control 9 and optics control 2. In addition, also microprocessor control means 4 is present. The microprocessor control means (e.g. integrated circuit (IC) means) contain both hardwired processing means and software processing means, so that e.g. a user, such as by means of a high-level control software, may influence the operation of the apparatus. Examples of high-level control settings include control of the pulse shape in a write strategy of the emitted laser power in recording mode.

In FIG. 2 is an example of optical effects on a Blu Ray disk (BD) provided. FIG. 2B illustrates a blow-up 29 of a region 20 on a BD disk 21 schematically illustrated in FIG. 2A. The blown-up region shows both optical effects 23 and regions 22 between the optical effects. The effects are aligned along a track spiraling from the center and outwards, a section 24 of a track is illustrated. Light reflected from the track section 24 is illustrated schematically in FIG. 2C, where the intensity of the reflected light is illustrated along the vertical axis 25 as a function of the position along the horizontal axis 26, i.e. as a function of the time. The optical effects 23 are often referred to as marks 27, whereas the region 22 in between the marks often are referred to as spaces 28. In a phase-change type disk, the marks 23,27 are amorphous regions with low reflectivity, whereas the spaces 22,28 are crystalline regions with high reflectivity.

In optical recording, data is stored in marks 27 and spaces 28 of different runlengths, i.e. different widths (lengths). Important for the optimal performance of a given disk is that all marks and spaces are integer step like. In BD, the shortest effects are 2 times the channel bit length (=unit length), also called T2's. The longest effects are 9 times the channel bit length and are called T9's. When the lengths of the marks and spaces are not exactly a multiple of the channel bit length, this will be seen as deviations from the optimal situation and will result in a deteriorated bit detection performance.

In FIG. 3, two series of channel bits from an optical signal is illustrated. The series of channel bits 30 comprising first sections 31 corresponding to light reflected from first regions with first widths 311, being spaces or high reflectivity regions, and second sections 32 corresponding to light reflected from second regions with second widths 321, being marks or low intensity regions. The transitions from the first to the second regions are labeled leading edges 33, and transitions from the second regions to the first regions are labeled trailing edges 34. As illustrated in FIG. 3B, the leading edges are indexed by the second and first widths, whereas the trailing edges are indexed by the first and second widths. Thus, the leading edge indicated with reference numeral 35 is indexed L(2,4) referring to a leading edge between a second region with a width of 2 (or runlength of 2) and a first region with a width of 4, i.e. a transition from a space with runlength 4 to a mark with runlength 2. Likewise, is the trailing edge indicated with reference numeral 36 indexed T(2,3) referring to a transition from a mark with runlength 2 to a space with runlength 3.

On a real disk, the transitions from a high reflectivity (space) to low reflectivity (mark) are not always on the right position. Some are too much to the left (early in time=negative per definition) and some too much to the right (too late=positive). This illustrated in FIG. 3A by the dotted lines 37 which indicate the measured edge position. In the figure a time axis 38 is illustrated as a horizontal axis, the time axis being discretized with so-called 1T (=1 channel bit) resolution. For an ideal signal, the transitions should lie on a 1T mark.

The subtle edge shifts (below the 1T resolution, as denoted by the dotted lines) may be included in a channel model description of a measured signal, e.g. by using the method as described by Pozidis et al. (see e.g. Pozidis, H.; Coene, W. M. J.; Bergmans, J. W. M.; Communications, 2000. ICC 2000. 2000 IEEE International Conference, vol. 1, 18-22 Jun. 2000, p 99-103), who modeled the effect of asymmetry on the CA-signal. By using not only −1's and +1's as the bit stream, but also numbers in between 39, it is possible to mimic edge shifts in a bit-synchronous way.

In the following is described an embodiment of an implementation of the present invention. Thus an embodiment of the implementation of a method of measuring the transition, or edge, shifts is described.

LT method: An important aspect of the method is that a model of the central aperture signal that includes the edge shifts is made. By comparing this model signal with the measured signal, the difference (=error) can be used to make a better estimate of the edge shifts. After one or more iterations, the model output may resemble the measured signal. The estimated edge shifts can be used to adapt the write strategy. Examples are described in sections below.

Only edge shifts that are systematic (with a predictable behavior) can be compensated in a write strategy. The marks have a leading and trailing edge, which can be shifted. These edge shifts are of course a function of the (current) mark length (I_{cm}). Furthermore, in the case of a leading edge, there might be influence of the previous space length (Iₚₛ), for example due to the thermal history, this effect can be seen as Inter Symbol Interference (ISI) in the write-channel. For the trailing edge, there might be influence of the next space (Iₙₛ). The shifts are written as a 2D matrix, with matrix elements L(cm,ps) for the leading edges and matrix elements T(cm,ns) for the trailing edges. The spaces are not dealt with, because they automatically fall in-between the written marks.

The method can be extended so that a leading edge is not only dependent on the previous but also the before previous effect (as well as the next effect and after next effect, but the LT-matrixes will have more dimensions and will grow rapidly).

Applying LT-matrixes: Applying an LT-matrix, i.e. multiplying the LT-matrix to the channel bit series, will result in a modified modulation bit stream äₖ also referred to as an LT-applied bit stream, where the edge shifts are incorporated. For every transition, from +1 to −1 and from −1 to +1, the two bits making up the transition are modified according the following rules:

Leading Edges (transition from space with run length y to mark of run length x):

| Mod. | Iy^{S} | | | Ix^{M} | | |
|---|---|---|---|---|---|---|
| Bits | . . . | +1 | +1 | −1 | −1 | . . . |
| L_{xy} > 0 | . . . | +1 | +1 | −1 + 2L_{xy} | −1 | . . . |
| L_{xy} < 0 | . . . | +1 | +1 + 2L_{xy} | −1 | −1 | . . . |

Trailing Edges (transition from mark with run length x to space of run length y):

| Mod. | Ix^{M} | | | Iy^{S} | | |
|---|---|---|---|---|---|---|
| Bits | . . . | −1 | −1 | +1 | +1 | . . . |
| T_{xy} > 0 | . . . | −1 | −1 | +1 − 2T_{xy} | +1 | . . . |
| T_{xy} < 0 | . . . | −1 | −1 − 2T_{xy} | +1 | +1 | . . . |

For example when only the I3's are written with a bit of overpower, (L3x=neg, T3x=pos, all other elements are zero), the following modified bit stream is obtained by applying the LT-method:

TABLE 1
The runlengths of the marks and spaces (first row), the modulation bits aₖ (second
row) and the LT-applied modulation bits āₖ (third row).

| I3^{S} | | | I3^{M} | | | I5^{S} | | | | | I2^{M} | | I4^{S} | | | | I3^{M} | | |
|---|---|---|---|---|---|---|---|---|---|---|---|---|---|---|---|---|---|---|---|
| 1 | 1 | 1 | −1 | −1 | −1 | 1 | 1 | 1 | 1 | 1 | −1 | −1 | 1 | 1 | 1 | 1 | −1 | −1 | −1 |
| 1 | 1 | 1 + 2L₃₃ | −1 | −1 | −1 | 1 − 2T₃₅ | 1 | 1 | 1 | 1 | −1 | −1 | 1 | 1 | 1 | 1 + 2L₃₄ | −1 | −1 | −1 |

LT Estimation Method: The CA-signal from the disk (r) can be mathematically described, e.g. by writing the CA signal on the following form:

rₖ=[h*(a+b)]ₖ+cₖ (1)

In which h is the channel impulse response (FIR), i.e. a discrete representation of the optical spot, a the bits on the disk and c a constant offset. Furthermore, b is defined as:

bₖ=äₖ−aₖ (2)

So b is the difference between the LT-applied bits as described in the previous section and the original (−1/1) bits. Thus b is a bit stream, which contains information about the edge shifts.
Next the model output (d) that is compared to the measured signal is defined by:

dₖ=└\tilde{h}*(a+\tilde{b})┘ₖ\tilde{c}ₖ (3)

In which the wiggles denote that these quantities are estimates. The estimates should converge to the “unknown” values coming from the disk (without wiggle).

The signal from the disk and the model that is used to fit this signal are defined, and their difference (error, e) can be found:

eₖ=rₖ−dₖ=[h*(a+b)+c]ₖ−└\tilde{h}*(a+\tilde{b})+\tilde{c}┘ₖ (4)

Which can be rewritten, to clearly show the different components:

eₖ=└(h−\tilde{h})*a┘ₖ+└(h*b−\tilde{h}*\tilde{b})┘ₖ+(Cₖ−\tilde{c}ₖ) (5)

The estimation of the channel can be done by correlating the error e with the channel bits a. This is called “Least Mean Square channel response estimation”, which works mathematically on the following principle:

$${e}_{k} ∝ {[ ( h - \tilde{h} ) * a ]}_{k} ⇒ ( {h}_{k} - {\tilde{h}}_{k} ) ∝ \frac{{e}_{k} \cdot {a}_{k}}{a \cdot {a}^{T}} = {e}_{k} * {a}_{k} \qquad ( 6 )$$

Thus, by a provision of an estimate of h, a new (and better) estimate can be made by using the following formula:

\tilde{h}ₖ₊₁=\tilde{h}ₖ+μₕ×(hₖ−\tilde{h}ₖ)=\tilde{h}ₖ+μₕ×(eₖ*aₖ) (7)

Looking at the second term in the error, that is related to the estimation of edge shifts (b), one can see that (b-b^{wiggle}) only can be expressed, when the estimate of h is close to the real h. In that case the error can be written:

$${e}_{k} ∝ {[ h * ( b - \tilde{b} ) ]}_{k} ⇒ ( {b}_{k} - {\tilde{b}}_{k} ) ∝ \frac{\tilde{h} * {e}_{k}}{\tilde{h} \cdot {\tilde{h}}^{T}} \qquad ( 8 )$$

And a new (and better) estimate is made by using:

$${\tilde{b}}_{k + 1} = {\tilde{b}}_{k} + {μ}_{b} \times ( {b}_{k} - {\tilde{b}}_{k} ) ⇒ {\tilde{b}}_{k + 1} = {\tilde{b}}_{k} + {μ}_{b} \times ( \frac{\tilde{h} * {e}_{k}}{\tilde{h} \cdot {\tilde{h}}^{T}} ) \qquad ( 9 )$$

As written down here, the estimate of b seems like a single variable, but in practice, its value depends on the runlength combinations in a. The above update rule should be applied to the corresponding LT-matrix element. In practice, the correct LT-element is updated at every leading or trailing edge in the channel bit stream a.
Finally, the constant offset c can be estimated based on:

eₖ∝(cₖ−\tilde{c}ₖ) (10)

So by integrating the error, that remains after the estimation of h and b (LT), one can estimate the constant offset using:

\tilde{c}ₖ₊₁=\tilde{c}ₖ+μ_{c}×(cₖ−\tilde{c}ₖ) [symbol] \tilde{c}ₖ₊₁=\tilde{c}ₖ+μ_{c}×eₖ (11)

Implementation: The LT estimation method can be implemented as illustrated in FIG. 4, where the aₖ channel bits 40 are first transformed into äₖ by the LT-apply method 41 with initial L and T matrixes. The äₖ are convoluted 42 with the channel response (FIR) (the transformed channel bits are transposed 45 to ensure multiplication of matrix elements), DC is added 43, and the LT-model output 44 is obtained. Next, the error signal 46 can be calculated, from comparison the model output and the measured waveform 47. The error signal can be integrated 48 for the DC-estimation and convoluted with the symmeterized channel bits aₖ^{Symm} 400 to obtain a new estimate of the FIR. Inside the LT-estimator 401, the right LT-element is taken (dependent on the runlengths of the aₖ channel bits) and updated by eq. (9). By using these updated LT-elements in the LT-apply block 41, the loop is closed, and the “fit” is made progressively better.

LT-Apply: The LT-apply block 41 is discussed further. Before a certain shift can be applied to a leading or trailing edge, the bit pattern which is passing by first have to be known, so that the correct element of the matrix is taken. For this the runlengths of the modulation bits currently passing is determined. This can be done by making a shift-register, which is long enough to hold the longest possible transition (I8/I8, so 16 bits). When bits are added to the shift-register, it is possible to make a runlength table which counts from the last inserted bit backward. This run-length table can be used to determine, which bit pattern is passing through the shift-register, and determine on which position inside the shift-register we have to apply which LT-element.

After the bits have passed through the shift-register, the out-coming bit stream can be convoluted with the FIR-estimate and been added to the DC-estimation to obtain the model output.

LT Estimation: The LT-estimation block 401 is discussed further. In this block, the run-lengths determined in the LT-apply method, are used to check if the incoming error (or actually the error convoluted with the FIR, see eq. (9)) is on a position around a leading or trailing edge. If this is the case, the correct LT-matrix element is taken and being updated with the following formula:

Lₑₛₜ(cm,ps)=Lₑₛₜ(cm,ps)+μ_{LT}·eₖ

L_{avg}(cm,ps)=(1−α)·L_{avg}(cm,ps)α·Lₑₛₜ(cm,ps)

Lᵥₐᵣ(cm,ps)=(1−α)·Lᵥₐᵣ(cm,ps)+α·(Lₑₛₜ(cm,ps)−L_{avg}(cm,ps))² (12)

So first, a new estimate is made by adding a fraction μ_{LT} of the error to the correct LT-element. Then a new running average can be recalculated and finally also a running variance (=standard deviation squared). The effective length over which the running average and variance are calculated is determined by the value of α.

Applications of the method of the present invention is described in the following in connection with experiments where the method according to the first aspect of the invention has been applied.

LT on phase-change disks: In a first example, a BD-RE disk is written at 33 GB with a standard write strategy. When the sampled waveform is processed the aₖ's and dₖ's are obtained. On these the full channel response estimation can run, resulting in a plot as shown in FIG. 5. In FIG. 5, all leading (FIG. 5A) and trailing (FIG. 5B) shifts are shown, and for every combination of current mark (x-axis) and prev/next space (y-axis) a dot 50 is drawn. The dot is found exactly on the cross-point 51 when there is no shift, and on the right 52 of it when there is a positive shift (too late) and on the left 53 of this cross-point when there is a negative shift (too early). As can be seen in FIG. 5, there is a slight amount of positive asymmetry, all leading shifts are a bit negative and all trailing shifts are a bit positive.

In order to obtain further insight into the application of the LT-method, the write strategy is changed a bit, and effects in the LT-matrixes are discussed.

First, the way the I2 is written is changed, this effect is already hardly visible, because it is beyond the cut-off of the MTF (=optical transfer function). In FIG. 6, a schematic drawing 60 of the 12-mark write strategy is shown. The write strategy comprises at least eight write parameters, four power levels (E, W, B, C) and a time duration for each. The laser starts with an erase level (E), then a writing pulse (W) is given, after which the power is reduced to bias level (B), in order to quench the phase-change material. Finally an erase pulse with power C is used to recrystallize a part of the amorphous mark in order to put the trailing edge on the right position. When the power level C is increased, more material should in crystallize, and thereby push-back the trailing edge. In FIGS. 7 and 8, the LT-analyses are respectively made for C=0.4*Pw (FIG. 7) and C=0.6*Pw (FIG. 8) (C=0.5*Pw being nominal). FIG. 7 shows the LT-matrixes when C is too low, so that there is not enough back-growth of the amorphous marks and the trailing edge is too much to the right. FIG. 8 shows the LT-matrixes when C is too high, so that there is too much back-growth of the amorphous marks resulting in that the trailing edge starts too early. It is seen that the trailing edges of the I2 marks are influenced by the C-level 70,71,80,81. Also quite important, as illustrated in FIG. 9 (showing the LT-matrixes from C=0.4 minus those of C=0.6), is that only the trailing edges of the I2 marks 90,91 are influenced by changing C. All other leading and trailing edges remain on their place; so hardly any cross-talk (Inter Symbol Interference, ISI) is observed. Due to this lack of cross-talk, the information of the edge shifts can be used in a very direct way to compensate the write strategy.

Similar measurements can be done when changing level D in the I3 write strategy 100 (as shown in FIG. 10). The resulting L and T matrixes can be found, and as in connection with the I2 write strategy, little cross-talk between the different components is seen. Only the edges of the I3 marks are influenced 110,111, and only the trailing edges 111 of the I3 marks are shifted to the right as illustrated in FIG. 11 showing the LT-matrixes from D=0.4 minus those of D=0.6.

The above results show that the LT-method can be used to measure the mis-adjustment of a very specific parameter in a write strategy. In this way, the LT-model can be used to control the several power-levels at the same time, because every parameter in a write strategy has its own specific influence.

Another method of controlling the write strategy is to use the measured edge shifts to modify the timing of the laser pulses in such a way that all effects will come on the right position. Based on the physics of phase-change recording; the write strategy adaptation 120 as shown in FIG. 12 has been used.

By shifting the first pulse, P₁, the leading edge can be shifted on the disk in a 1-to-1 fashion. So if we measure that a leading edge is 2/16 of a T too early, the write strategy can be adapted by giving the first pulse 2/16 of a T later (similar for trailing part).

The results of applying this method can be seen in the next figures. In FIG. 13, the LT-measurements after writing with a simple write strategy are shown. These shifts are used to generate a new write strategy. When we write with this new strategy, and redo an LT-measurement, we obtain FIG. 14. As can be seen, almost no systematic deviations are seen anymore. Furthermore, all asymmetry is taken out of the signal, although we still use the same power. As shown, the LT-method makes a 1-step write-strategy optimization possible.

LT on write-once disks: The LT-model can also be used in connection with write-strategies for write-once disks, to compensate a leading/trailing edge that is x/16 of a T too early or too late. In this case it should be determined how much the write strategy should be changed to move a leading or trailing edge with an amount x/T on the disk. To investigate this the following the write strategy of the I4's are changed. The write pulse 150 of an I4 is illustrated in FIG. 15

The following experiment has been performed on a Si/Cu write-once disk. The way the I4's are written is changed and the effects of this on the LT-elements is analyzed. By changing the duration of the last pulse P_{L} (removing/adding at the back-end), the position of the trailing edge changes. By making the last pulse 1/16th of a T longer, the trailing edge of the I4 is moved ˜ 3/16T. The observed relation between last pulse duration and trailing edge position is found to be linear, so this can be used to put trailing edges on the right position. However, due to the writing mechanism, this dependence is very sensitive. When trailing edges need to be positioned on the disk with a 1/16T resolution, 3 times as much resolution (so 1/48T) is needed from the laser-driver. It is found that shifting the last pulse hardly affects the trailing edge position. This is due to the writing process in a write-once stack, which senses the total amount of power that heats up the stack. The position of the trailing edge, is determined by the point where, due to cooling, the temperature drops below the threshold. Changing the moment when this power is injected hardly influences the moment when the temperature drops below the threshold, because it doesn't change the amount of injected power. Looking at the influence of changing the first pulse on the LT-elements more cross talk between the leading and trailing edge occurs. For example when the first pulse is shifted, not only the moment when the temperature rises above the writing threshold changes, but also the moment when it cools down to below the threshold will change. This results in a strong cross talk, which will make this method difficult to use in compensating an arbitrary leading edge shift and trailing edge shift at the same time.

By changing the first pulse length 151, by starting a bit later or earlier, one can easily move the leading edge. Also in this case, the edge shift is about 3 times as large as the change in pulse length. Furthermore, because shifting the start of the first pulse to the right will reduce the total power injected into the stack, the temperature will raise less and so at the trailing edge the temperature will come earlier through the threshold. This results in a trailing edge shift with an opposite slope. It is clear that changing the length of the first pulse is a much more effective way of positioning the leading edge than by shifting the first pulse. Because there is little cross talk, the control of the leading edge position can be seen (almost) independent of the control of the trailing edge position.

LT on ROM disks: An important application of the LT-model is its use on ROM disks. The positions of the ROM pits (marks) and lands (spaces) are determined by the way the laser beam recorder (LBR) exposes the photosensitive layer during the mastering process. After this step, many other steps are needed to finally obtain a master stamper. With this stamper, one can make ROM disks by injection moulding. If one likes to optimize the effect lengths and positions, the problem is the long delay between the mastering process and the moment you can finally measure the quality of the ROM disk. In such a case, it would be very important to be able to do a 1-step optimization of the exposure/write strategy. As shown in the case for a rewritable disk, the LT-model can provide you with the information to make this possible.

An important situation is a situation where only the I2's are written too short and all other effects are perfectly on their position, and where this effect is almost independent of the laser power that has been used for exposing the photosensitive layer. The leading edges of the I2's may arrive too late and the trailing edges may arrive too early compared to the I3 to I8 marks. This effect may be stronger for increased capacities.

The effect can be understood by calculating the integrated exposure dose of a moving gaussian spot that is turned on for a certain time. If one uses a photo-sensitive material with a sharp threshold behavior, only the long effects start in a proper way, but if the laser durations are short, the point where the exposure reaches the threshold level will start a bit later and end a bit earlier. This result correlates with observed edge shifts. The effect can be very abrupt, so that it will only affects the I2's and not the I3 to I8's.

The embodiments as described in this section can be used to extract leading and trailing edge shifts from synchronous central aperture signals and the detected bits. The shifts are measured as they are physically on the disk, which make relatively simple compensation methods feasible.

Embodiments of the present invention can be applied to RW, R and even ROM disks. On RW and R disks, very efficient methods to optimize a write strategy in few steps are provided. As shown on RW disks power control methods can be provided which selectively provide subtle variations in specific power levels in a write strategy. Furthermore, the timing of the write and erase pulses can be adapted in a write strategy and all found deviations can be compensated even in a 1-step optimization process. On R disks, the sensitivity of the leading and trailing edges on position and duration of the laser pulses has been shown. On ROM disks, analyses of the central aperture signal showed that the I2 marks are written with less asymmetry than all other marks.

The method works well on conventional capacities (up to 27 GB for BD) as well as on capacities above (such as 30-37 for BD), where the shortest runlengths are beyond the optical cut-off. So in the case of 33 GB BD, the present invention provides means to see whether the I2's are written too small or on the wrong position.

Furthermore, the method does not suffer from slicer effects. Due to this effect, a time interval analyzer (TIA) reports changes in all I3's to I8's when the length/position of the I2 is changed. This “cross-talk” makes it very difficult to use cloud-plots measured with a TIA to automatically compensate a write strategy.

Embodiments of the present invention may be integrated into an IC, to improve the writability of a drive, providing the possibility to do very rapid write-strategy optimization (even on a-priori unknown media).

Although the present invention has been described in connection with preferred embodiments, it is not intended to be limited to the specific form set forth herein. Rather, the scope of the present invention is limited only by the accompanying claims.

In this section, certain specific details of the disclosed embodiment such as method steps, specific mathematical models, data representation etc., are set forth for purposes of explanation rather than limitation, so as to provide a clear and thorough understanding of the present invention. However, it should be understood readily by those skilled in this art, that the present invention may be practiced in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. Method of determining the timing of transition shifts (37) in a series of channel bits (30) in a measured optical signal from an optical recording medium (11), the optical signal comprising first sections (28,31) reflected from first regions (22) with first widths (311), and second sections (27,32) reflected from second regions (23) with second widths (321), wherein transitions from the first to the second regions are labeled leading edges (33) indexed by the first and second widths and transitions from the second regions to the first regions are labeled trailing edges (34) indexed by the second and first widths, the method comprising the steps of:
a) providing values of a measured optical signal in the form of a central-aperture signal (CA signal),
b) providing modulation bits corresponding to the measured optical signal,
c) calculating a model signal by means of an optical channel model, the calculated model including an input timing of the leading and trailing edges, the input timing being a series of input transition shifts,
d) determining an output timing of the leading and trailing edges from a mathematical model talking the measured optical signal, the modulation bits and the calculated model signal in account, the output timing being a series of output transition shifts,
wherein the input timing used in an evaluation step is the output timing determined in a precedent evaluation step, and wherein the difference between the model and measured signal is used together with the input timing to calculate a subsequent output timing, and
e) continuing the evaluation series until a series of output transition shifts obtained in a specific evaluation step fulfils a predetermined criterion,
wherein the last obtained series of output transition shifts is the average transition shifts (500,501) of the channel bits of the measured CA signal.

2. Method according to claim 1, wherein the calculated model signal is represented by a linear optical model approximated by a discrete finite impulse response (FIR) implementation.

3. Method according to claim 1, wherein both the measured optical signal and the calculated model signal are represented by a bit-synchronous approximation, synchronous with the modulation bits on the optical medium.

4. Method according to claim 1, wherein the difference between the model and the measured signal is minimized in an error loop where the mean square error is minimized.

5. Method according to claim 1, wherein the timing of the leading (500) and trailing (501) edges are determined as a function of width of the region prior to a specific transition shift and the width of the following region.

6. Method according to claim 1, wherein one or more write parameters (E,W,B,C,D) in a write pulse (60,100,120,150) for writing a specific optical effect on an optical medium is optimized according to an average transition shifts of a specific type of leading and/or trailing edge.

7. Method according to claim 6, further comprising the steps of:
α) reading a pattern (29) of optical effects (23) from an optical storage medium (11), the pattern including one or more optical effects, each of the one or more optical effects being associated with a predetermined write strategy (60,100,120,150), the write strategy including one or write parameters (E,W,B,C,D),
β) performing the method of claim 1 and thereby provide the average transition shifts of the channel bits of the measured CA signal, and
γ) adjusting the one or more write parameters by means of a set of predetermined rules.

8. Method according to claim 7, wherein an addition pattern of optical effects is provided to the optical storage medium by using the adjusted write parameters and repeating the steps α) β) and γ).

9. Method according to claim 7, wherein the one or more write parameters include the power level and/or a level duration (151).

10. Module for running the method of claim 1, the module comprising:
a first input section for inputting the CA signal in a form of a measured sampled waveform,
a second input section for inputting a channel bit stream,
means for processing the CA signal and the channel bit stream in accordance with the method of claim 1, and
an output section for outputting the average transition shifts of the channel bits of the measured CA signal, and
optionally processing means for evaluating the transition shifts in accordance with rules.

11. Optical recording apparatus (1) comprising:
a radiation source (6) for emitting a radiation beam (3) having a controllable value of a write power level (P) for recording optical effects (23) on the recording medium,
a read unit (7) for reading the recorded effects and forming corresponding read signal portions,
means adjusting the power level and/or level duration in a write strategy according to the average transition shifts (500,501) of a specific type of leading and/or trailing edge of the measured CA signal as determined by the method of claim 1.

12. Integrated circuit (IC) for controlling an optical recording apparatus, the IC being adapted to adjusting one or more write parameters in a write strategy according to the average transition shifts of a specific type of leading and/or trailing edge of the measured CA signal as determined by the method of claim 1.

13. Computer readable code adapted to perform the method of claim 1.
